(19) United States
(12) Patent Application Publication
(10) Pub. No.: US 2010/0104161 A1
(43) Pub. Date: Apr. 29, 2010

(54) PROJECTION SYSTEM FOR PRODUCING ATTENUATION COMPONENTS

(75) Inventors: Andy Ziegler, Kelburn/Wellington (NZ); Ewald Roessl, Ellerau (DE); Roland Proksa, Hamburg (DE)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N. V., Eindhoven (NL)

(21) Appl. No.: 12/529,715

(22) PCT Filed: Mar. 3, 2008
(86) PCT No.: PCT/IB08/50767

§ 371 Date: Sep. 3, 2009

(30) Foreign Application Priority Data
Mar. 7, 2007 (EP) 07103713.9

(51) Int. Cl. G06T 5/00

(52) U.S. Cl. 382/131

(57) ABSTRACT

The invention relates to a projection system for producing attenuation components of projection data of a region of interest. The projection system comprises a projection data providing unit (1, 2, 6, 7, 8) for providing energy-dependent projection data of the region of interest. The projection system further comprises a calculation unit (12) for calculating different attenuation components generated by different attenuation effects from the energy-dependent projection data, wherein the different attenuation components contribute to the projection data and a transformation unit (13) for transforming the attenuation components such that a correlation of the attenuations components is reduced. The invention relates further to a corresponding projection method and a corresponding computer program.

### FIELD OF THE INVENTION

The present invention relates to a projection system, a projection method and a computer program for producing attenuation components of projection data.

### BACKGROUND OF THE INVENTION

A projection system is, for example, a computed tomography system, which generates projection data and reconstructs an image of a region of interest using the projection data. U.S. Pat. No. 5,115,394 discloses a dual energy-tomography scanning system, which acquires projection data at two different energy levels. Photoelectric and Compton components of the projection data are determined as attenuation components, and a photoelectric image is reconstructed from the photoelectric components and a Compton image is reconstructed from Compton components. The photoelectric and the Compton images are filtered separately such that after the filtered photoelectric image and the filtered Compton image have been combined to a final image, correlated noise in the final image is reduced. But, the final image still comprises a large amount of correlated noise, which diminishes the signal-to-noise ratio.

### SUMMARY OF THE INVENTION

It is an object of the present invention to provide a projection system for producing attenuation components of projection data of a region of interest, wherein the correlated noise, and therefore the signal-to-noise ratio, in the attenuation components of the projection data, and thus in the projection data, is reduced.

In a first aspect of the present invention a projection system for producing attenuation components of projection data of a region of interest is presented, which comprises
a projection data providing unit for providing energy-dependent projection data of the region of interest,
a calculation unit for calculating different attenuation components generated by different attenuation effects from the energy-dependent projection data, wherein the different attenuation components contribute to the projection data,
a transformation unit for transforming the attenuation components such that a correlation of the attenuation components is reduced.

The projection data providing unit can be a storage for storing energy-dependent projection data of a projection data generation unit, which is, for example, a combination of a radiation source for generating radiation for traversing the region of interest, a motion unit for moving the radiation source and the region of interest relatively to each other for illuminating the region of interest from different directions and a detection unit for detecting energy-dependent projection data depending on the radiation after having traversed the region of interest, wherein this combination is, for example, a part of a computed tomography system or a C-arm X-ray system. The projection data providing unit can also be any other combination of radiation source, in particular an X-ray radiation source, and a detection unit. The projection data providing unit can also be a storage unit for storing energy-dependent projection data or a computer program for providing simulated energy-dependent projection data.

The attenuation components are, for example, a Compton component caused by the Compton effect, a photoelectric component caused by a photoelectric effect and/or a K-edge component caused by a K-edge of a material, for example, of a contrast agent, within the region of interest. The attenuation components can also be related to different materials in the region of interest. For example, if a patient is located in the region of interest, a first attenuation component can be related to the attenuation caused by bones and a second attenuation component can be related to the attenuation caused by soft tissue.

The invention is based on the idea, that the correlated noise in the attenuation components and, thus, in the projection data, can be reduced by determining the attenuation components and by transforming the attenuation components such that the correlation of the attenuation components of the projection data is reduced, in particular eliminated. Since the correlation of the attenuation components is reduced, also the correlated noise is reduced, thereby increasing the signal-to-noise ratio of the attenuation components of the projection data and, thus, the signal-to-noise ratio of the projection data.

It is preferred that the transformation unit transforms the different attenuation components to the same unit. Since the different attenuation components are transformed to the same unit, further processing, in particular further transformation, of the attenuation components is simplified.

It is further preferred that the transformation unit is adapted for
determining for each of several projection data a position within an attenuation component space, whose orthogonal axes are spanned by the attenuation components, wherein a set of projection data positions within the attenuation component space is formed,
determining major and minor axes of the set of projection data positions within the attenuation component space,
transforming the attenuation components such that the axes of the attenuation component space are parallel to the determined major and minor axes of the set of projection data positions. The term “axes are parallel to the determined major and minor axes” also includes the case that the axes of the attenuation component space are identical to the determined major and minor axes of the set of projection data positions.

After the foregoing transformation of the attenuation components, in the attenuation components space a variation of one attenuation component is a variation substantially parallel to an axis of the attenuation component space, i.e. the value of an other attenuation component is substantially not modified, i.e. in the attenuation component space the correlation between different attenuation components is reduced or not present anymore, thereby reducing the correlated noise in the attenuation components.

It is further preferred that the transformation unit is adapted for performing a rotational transformation such that the correlation of the attenuation components is reduced. It has been observed that the correlation can be reduced by a rotational transformation of attenuation components. In particular, a rotational transformation is generally sufficient for transforming the attenuation components such that the axes of the attenuation component space are parallel to determined major and minor axes of a set of projection data positions.

It is further preferred that the projection system further comprises a processing unit for processing the attenuation components after having been transformed such that the correlation is reduced. The processing unit is preferentially adapted for filtering the attenuation components. Since the attenuation components are transformed such that the correlation is reduced, in particular no more present, each attenuation component can be processed without or with a reduced effect to other attenuation components.

In a preferred embodiment, the projection system further comprises an inverse transformation unit for applying an inverse transformation to the processed attenuation components, which is inverse to the transformation of the transformation unit.

It is further preferred that the projection system further comprises a reconstruction unit for reconstructing an image of the region of interest using the transformed attenuation components. Since the transformed attenuation components have a reduced correlation, in particular do not have any correlation, an image, which has been reconstructed using the transformed attenuation components, comprises a reduced in particular no correlated noise, thereby improving the signal-to-noise ratio of the reconstructed image. Furthermore, the transformed attenuation components can be filtered, for example, such that the noise within the transformed attenuation components is further reduced, for example by using an averaging filter. The filtered transformed attenuation components can be inversely transformed, and these inversely transformed filtered attenuation components can be used for reconstructing an image of the region of interest. Since the transformed attenuation components comprise a reduced correlation in particular since they are uncorrelated, the filtering of each attenuation component can be performed without disturbing the other attenuation components. Thus, the transformed attenuation components can be filtered such that the noise of the attenuation components is further reduced and these attenuation components comprising less noise can be further processed to reconstruct an image of the region of interest.

In a further aspect of the present invention a projection method for producing attenuation components of projection data of a region of interest is presented, which comprises following steps:
providing energy-dependent projection data of the region of interest,
calculating different attenuation components generated by different attenuation effects from the energy-dependent projection data, wherein the different attenuation components contribute to the projection data,
transforming the attenuation components such that a correlation of the attenuation components is reduced.

In a further aspect of the present invention a computer program for producing attenuation components of projection data of a region of interest is presented, the computer program comprising program code means for causing a projection system as defined in claim 1 to carry out the steps of the method as claimed in claim 8, when the computer program is run on a computer controlling the projection system.

It shall be understood that the projection system of claim 1, the projection method of claim 8 and the computer program of claim 9 have similar and/or identical preferred embodiments as defined in the dependent claims.

It shall be understood that preferred embodiments of the invention can also be combinations of, for example, two or more dependent claims with the respective independent claim.

### BRIEF DESCRIPTION OF THE DRAWINGS

These and other aspects of the invention will be apparent from and elucidated with reference to the embodiments described hereinafter. In the following drawings:

FIG. 1 shows schematically an embodiment of a projection system for producing attenuation components of projection data of the region of interest.

FIG. 2 shows a flowchart illustrating an embodiment of a projection method for producing attenuation components of projection data of a region of interest.

FIG. 3 shows schematically and exemplarily an energy dependence of a photoelectric effect and a Compton effect.

FIG. 4 shows a flowchart illustrating a transformation of attenuation components.

FIG. 5 shows schematically and exemplarily a set of projection data positions in an attenuation component space.

FIG. 6 shows schematically and exemplarily the set of projection data positions in an attenuation component space after a rotational transformation.

### DETAILED DESCRIPTION OF EMBODIMENTS

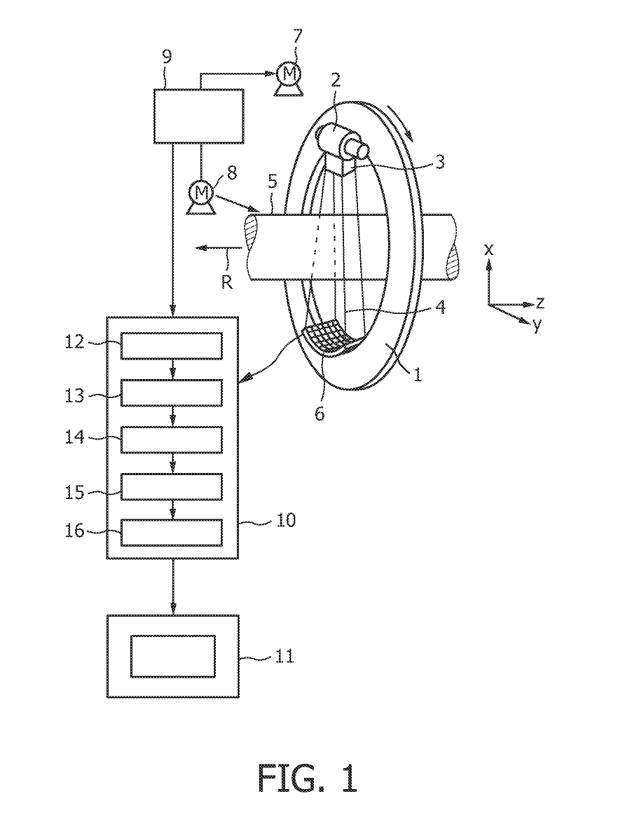

FIG. 1 shows a projection system being a computed tomography imaging system, which includes a gantry 1, which is capable of rotation about an axes of rotation R which extends parallel to the z direction. A radiation source, which is an X-ray tube 2 in this embodiment, is mounted on the gantry 1. The X-ray tube 2 is provided with a collimator device 3 which forms a conical radiation beam 4 from the radiation emitted by the X-ray tube 2. In other embodiments, the collimator device 3 can be adapted for forming a radiation beam having another shape, for example, having a fan shape.

The radiation traverses a region of interest of an object (not shown), such as a patient, in a cylindrical examination zone 5. After having traversed the examination zone 5, the X-ray beam 4 is incident on an energy-resolving detection unit 6, in this embodiment a two-dimensional detector, which is mounted on the gantry 1. In another embodiment, the energy-resolving X-ray detection unit can be a one-dimensional detector.

Energy-resolving X-ray detection units work, for example, on the principle of counting the incident photons and output a signal that shows the number of photons per energy in a certain energy window. Such an energy-resolving detection unit is, for instance, described in Llopart, X., et al. “First test measurements of a 64 k pixel readout chip working in a single photon counting mode”, Nucl. Inst. and Meth. A, 509 (1-3): 157-163, 2003 and in Llopart, X., et al., “Medipix2: A 64-k pixel readout chip with 55 μm square elements working in a single photon counting mode”, IEEE Trans. Nucl. Sci. 49(5): 2279-2283, 2002.

The gantry 1 is driven at a preferably constant but adjustable angular speed by a motor 7. A further motor 8 is provided for displacing the object, for example, the patient who can be arranged on a patient table in the examination zone 5, parallel to the direction of the axis of rotation R or the z axis. These motors 7, 8 are controlled by a control unit 9, for instance, such that the radiation source 2 and the examination zone 5 move relative to each other along a helical trajectory. It is also possible that the object or the examination zone 5 is not moved and that the radiation source 2 is rotated, i.e. that the radiation source 2 travels along the a circular trajectory relative to the object.

The data acquired by the detection unit 6 are projection data, which are provided to a calculation system 10. The radiation source 2, the detection unit 6, the gantry 1, the motors 7, 8 and preferentially the displacement means, which can displace the object in the z direction and which is preferably a patient table, form a projection data providing unit. In other embodiments, the projection data providing unit can also be a storage unit, in which projection data are stored and which provides these projection data to the calculation system 10. In this embodiment, the calculation system 10 reconstructs an image of the region of interest using the acquired projection data. The reconstructed image can finally be provided to a display unit 11 for displaying the reconstructed image.

The calculation system 10 comprises a calculation unit 12 for calculating different attenuation components generated by different attenuation effects from the projection data, wherein the projection data are energy-dependent projection data and wherein the different attenuation components contribute to these projection data. The calculation system 10 further comprises a transformation unit 13 for transforming the attenuation components such that a correlation of the attenuation components is reduced. The calculation system 10 also comprises a processing unit 14, which is in this embodiment a filtering unit 14, for processing the attenuation components after having been transformed such that the correlation is reduced. In addition, the calculation system 10 comprises an inverse transformation unit 15 for applying an inverse transformation to the processed attenuation components, which is inverse to the transformation of the transformation unit 13. Furthermore, the calculation system 10 comprises a reconstruction unit 16 for reconstructing an image of the region of interest using the transformed attenuation components. In this embodiment, the transformed attenuation components are used by firstly processing the transformed attenuation components by the processing unit 14 and by inversely transforming the processed attenuation components by the inverse transformation unit 15, and secondly by reconstructing an image of the region of interest from the inversely transformed projection data by the reconstruction unit 16. In another embodiment, the calculation system can only comprise the calculation unit 12, the transformation unit 13 and the reconstruction unit 16, wherein an image of the region of interest is reconstructed directly from the transformed attenuation components provided by the transformation unit 13. In a further embodiment, the calculation system can only comprise or only use the calculation unit 12 and the transformation unit 13 and can provide the transformed attenuation components as projection data, which have reduced correlated noise and which can be shown on the display unit 11.

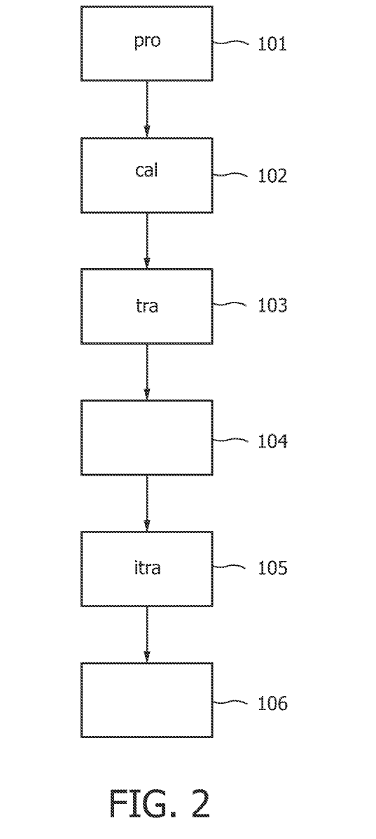

In the following an embodiment of a projection method for producing attenuation components of projection data of a region of interest in accordance with the invention will be described in more detail with reference to a flowchart shown in FIG. 2.

In step 101, energy-dependent projection data are provided. In this embodiment, the energy-dependent projection data are provided by rotating the X-ray tube 2 around the axis of rotation R of the z axis and by not-moving the object, i.e. the X-ray tube 2 travels along a circular trajectory around the object. In another embodiment, the X-ray tube 2 can move along another directory, for example, a helical directory, relative to the object or the region of interest. The X-ray tube 2 emits X-ray radiation traversing the region of interest of the object. The X-ray radiation, which has traversed the region of interest, is detected by the detection unit 6, thereby generating energy-dependent projection data. In this embodiment, the radiation source 2 emits polychromatic radiation and the detection unit 6 is an energy-resolving detection unit in order to generate energy-dependent projection data. In another embodiment, projection data can be acquired at least twice, wherein different energy distributions of the radiation emitted from the radiation source are used, for example, by using different voltages of an X-ray tube or by using different filters, and wherein a non-energy-resolving detection unit can be used. The energy dependence of the projection data is than caused by the different energies of the radiation incident on the region of interest. If different energies of the radiation incident on the region of interest are used, the energy resolution of the protection data can be further increased by using an energy-resolving detection unit.

The energy-dependent projection data are transmitted to the calculation unit 12 of the calculation system 10, and in step 102 the calculation unit 12 calculates different attenuation components generated by different attenuation effects from the energy dependent projection data, wherein the different attenuation components contribute to the energy-dependent projection data. This calculation of the attenuation components will in the following be explained in more detail.

In this embodiment, the attenuation components are the photoelectric component Aₚ of the projection data caused by the photoelectric effect and the Compton component A_{C} caused by the Compton effect. The energy dependence of the photoelectric effect ƒₚ(E) and the energy dependence of the Compton effect ƒ_{C}(E) are known and schematically and exemplarily shown in FIG. 3. The relationship between the energy-dependent projection data M and the attenuation components of the projection data, i. e. in this embodiment the photoelectric component Aₚ and the Compton component A_{C}, can, for example, be formulated by following equation:

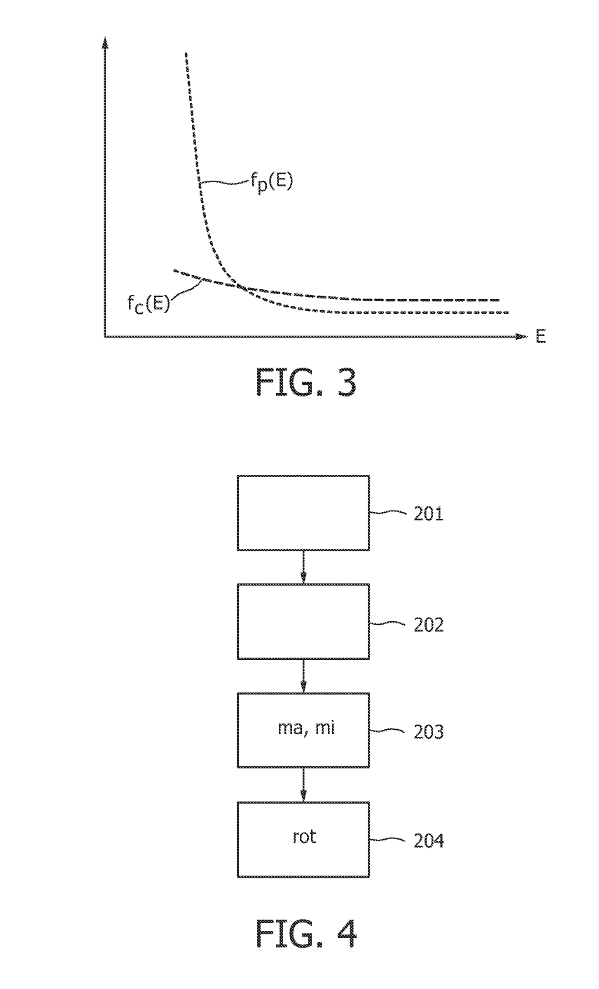

Mᵢ(Aₚ,A_{C})=cᵢ∫Sᵢ(E)Φᵢ(E)e^{-ƒ}^{ₚ}^{(E)A}^{ₚ}^{-ƒ}^{_{c}}^{(E)A}^{_{C}}Dᵢ(E)dE, (1)

where i labels the measurements with different spectral encoding, φᵢ(E) is the incoming, polychromatic x-ray spectrum, Dᵢ(E) is the so-called detector absorption efficiency, Cᵢ is a constant, and Sᵢ(E) determines the way the photons are processed in the detector, i.e. for an e.g. integrating detector Sᵢ(E)=E, and for an e.g. counting detector Sᵢ(E)=1 . In the simplest case with two spectrally encoded measurements (which do not need to be taken one after the other in time), we have i=1,2 . This means we have two measurements M₁, M₂ and two unknown Aₚ, A_{C} and can e.g. solve this system of equations numerically, which returns the values for Aₚ and A_{C}. Such a determination of alternation components is, for example, disclosed in “Energy-selective reconstructions in x-ray computerized tomography”, Alvarez, E. R., Macovski, A., Phys. Med. Biol., 21, 733-744 (1976), which is herewith incorporated by reference. In step 103, the attenuation components are transformed by the transformation unit 13 such that a correlation of the attenuation components is reduced. This transformation will in the following be described in more detail with respect to a flowchart shown in FIG. 4.

In step 201 the transformation unit 13 transforms the different attenuation components to the same units. In this embodiment, this is performed by multiplying the attenuation components with the respective energy-dependent function, i.e. the Compton component A_{C} and the photoelectric component Aₚ are preferentially transformed according to following equations:

A_{C}ⁱ=A_{C}ƒ_{C}(Eₒ)and (2)

Aₚⁱ=Aₚƒₚ(Eₒ). (3)

In equations (2) and (3) A_{C}ⁱ and Aₚⁱ denote the attenuation components, which have been transformed to same units. The energy Eₒ can be any energy, for which projection data are available. Preferentially Eₒ is in the range of 60 to 100 keV and it is further preferred that Eₒ is 80 keV.

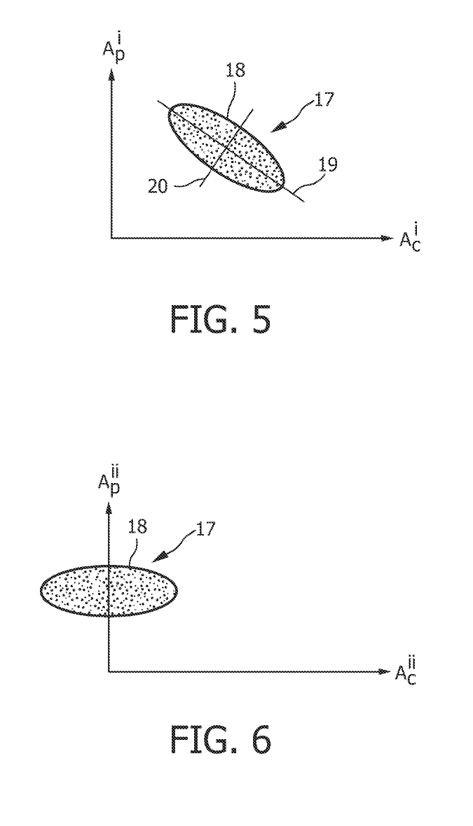

In step 202, for each of several projection data, in particular for all projection data, a position within an attenuation component space spanned by the attenuation components is determined, wherein a set of projection data positions within the attenuation component space is formed, i.e. each projection data value is a combination of different attenuation components, in this embodiment of the Compton component and the photoelectric component, and each projection data value is positioned in the attenuation component space at a position which corresponds to the respective Compton component and photoelectric component. The resulting set of projection data positions 17 is schematically shown in FIG. 5. The set of projection data positions 17 has, in this embodiment, a substantially elliptical shape, which is indicated in FIG. 5 by an ellipse 18.

In step 203, the major axis 19 and the minor axis 20 of the ellipse 18 are determined.

In step 204, the attenuation components are transformed such that the axes of the attenuation component space, which is now spanned by the transformed attenuation components, are parallel to the major and minor axes 19, 20 of the set of projection data positions, i.e. of the ellipse 18 in this embodiment, defined in step 203. This transformation is preferentially performed by a rotational transformation such that the axis of the attenuation component space spanned by the transformed attenuation components are parallel to the determined major and minor axes 19, 20. The resulting set of projection data positions in the attenuation component space is schematically shown in FIG. 6.

The transformation of the transformed attenuation components Aₚⁱ and A_{C}ⁱ can be modeled by following equation:

$$( \begin{matrix}{A}_{C}^{ii} \\ {A}_{p}^{ii}\end{matrix} ) = {R}_{Θ} ( \begin{matrix}{A}_{C}^{i} \\ {A}_{p}^{i}\end{matrix} ) \qquad ( 4 )$$

wherein A_{C}ⁱⁱ and Aₚⁱⁱ are the rotated attenuation components and wherein R _{Θ} is the rotational transformation, which rotates the attenuation components A_{C}ⁱ and Aₚⁱ by the rotational angle Θ.

The rotational angle Θ is, in this embodiment, the rotational angle, which is needed to perform a rotational transformation such that the axes of the attenuation component space are parallel to the major and minor axes 19, 20 of the ellipse 18. The rotational angle Θ can also be determined such that the axes of the attenuation component space are parallel to straight lines through the set of projection data positions 17, wherein these straight lines have been determined such that a sum of absolute differences of the positions of the projection data to the straight lines is minimized. Such a determination of the straight lines preferentially leads to straight lines, which are substantially equal to the major and minor axes 19, 20 schematically shown in FIG. 5. In another embodiment the rotational angle can be determined by using following equation:

Θ=0.5·tan⁻¹(cov/(v_{C}−vₚ)), (5)

wherein cov is the covariance and v_{C} and vₚ are the variances of the Compton and photoelectric attenuation components, respectively, after having been transformed to same units.

The correlation of the transformed attenuation components A_{C}ⁱⁱ and Aₚⁱⁱ is reduced, preferentially these two components are uncorrelated.

The determination of the rotational angle Θ is in this embodiment performed for each projection, i.e., in this embodiment the transformation of the attenuation components can differ from projection to projection, wherein a projection is defined by the group of projection data, which correspond to the same position of the radiation source relative to the region of interest. In other embodiments, the rotational angle can be determined for a group of projection data having more or less projection data, in particular, one rotational angle can be determined for all projection data.

The description of the flowchart shown in FIG. 2 will now be continued.

In step 104, the transformed attenuation components A_{C}ⁱⁱ, Aₚⁱⁱ are processed, in particular filtered. In this embodiment, the attenuation components are filtered such that the noise is further reduced, for example, by using an averaging filter. Also other processing steps can be performed in step 104. Since the transformed attenuation components A_{C}ⁱⁱ, Aₚⁱⁱ are uncorrelated or have at least a reduced correlation, the processing of the attenuation component A_{C}ⁱⁱ does not influence the attenuation component Aₚⁱⁱ or this influence is reduced and vice versa.

In step 105, the inverse transformation unit 15 inversely transforms the processed attenuation components. In this embodiment, the inverse transformation consists of an inverse rotation and the inversion of the transformation performed in step 201, i.e. the transformation such that different attenuation components have the same unit will be inverted. The inverse rotation can be modeled by following equation:

$$( \begin{matrix}{A}_{C}^{iv} \\ {A}_{p}^{iv}\end{matrix} ) = {R}_{Θ}^{- 1} ( \begin{matrix}{A}_{C}^{iii} \\ {A}_{p}^{iii}\end{matrix} ) , \qquad ( 6 )$$

wherein A_{C}ⁱⁱⁱ and Aₚⁱⁱⁱ are the processed attenuation components resulting from step 104, wherein the transformation R_{Θ}⁻¹ is a rotational transformation, which is inverse to R_{Θ} and wherein A_{C}^{iv} and Aₚ^{iv} are the attenuation components resulting from the inverse rotation. The next transformation, which inverts the transformation of step 201, can be modeled by following equations:

$$\begin{matrix}{A}_{C}^{v} = \frac{{A}_{C}^{iv}}{{f}_{C} ( {E}_{0} )} \\ and & ( 7 ) \\ {A}_{p}^{v} = \frac{{A}_{p}^{iv}}{{f}_{p} ( {E}_{0} )} , & ( 8 )\end{matrix}$$

wherein A_{C}^{v} and Aₚ^{v} are the inversely transformed attenuation components.

In step 106, the reconstruction unit 16 reconstructs an image of the region of interest using the inversely transformed attenuation components A_{C}^{v} and Aₚ^{v}, for example, by using a filtered back projection.

While the invention has been illustrated and described in detail in the drawings and the foregoing description, such illustration and description are to be considered illustrative or exemplary and not restrictive. The invention is not limited to the disclosed embodiments.

Although in the above described embodiments mainly two attenuation components, i. e. the Compton component and the photoelectric component, are considered, also more and/or other attenuation components can be used. For example, in addition or as an alternative, a K-edge component caused by a K-edge of a material like a contrast agent within the region of interest can be used as an attenuation component. Also further K-edge components caused by the same material or by other materials can be used as attenuation components. Furthermore, the attenuation components can also be related to different materials in the region of interest, i. e. the attenuation within the region of interest can be modeled as a combination of an attenuation caused by a first material, which might be bone material, and an attenuation caused by a second material, which might be a soft tissue material. These different possibilities of combinations of attenuation components, which contribute to the attenuation within the region of interest and, therefore, to the acquired projection data, are, for example, described in

“Basis material decomposition using triple-energy X-ray computed tomography”, Sukovic et al., IEEE Instrumentation and Measurement Technology Conference, Venice, 3, pp. 1615-8, 1999 and “Energy-selective Reconstructions in X-ray Computerized Tomography”, Alvarez et al., Phys. Med. Biol., 1976, Vol. 21, No. 5, 733-744, which are herewith incorporated by reference. These cited documents also describe a calculation of different attenuation components generated by different attenuation effects from the energy dependent projection data. Also this description is herewith incorporated by reference.

Since in the above described embodiment two attenuation components have been determined, the set of projection data positions in the attenuation component space comprises two orthogonal axes, a major axis and a minor axis. If more or less attenuation components are determined, more or less major and minor axes are present. The number of determined attenuation components corresponds to the number of orthogonal major and minor axes, and the number of orthogonal axes of the attenuation component space corresponds to the number of attenuation components. The rotational angle is then determined such that the major and minor axes of the set of projection data positions are parallel to the axes of the attenuation component space. For example, in another embodiment, in which exemplarily three attenuation components Aₚⁱ, A_{c}ⁱ and A₃ⁱ have been determined, the transformation of the transformed attenuation components Aₚⁱ and A_{C}ⁱ and A₃ⁱ can be modeled by following equation:

$$( \begin{matrix}{A}_{C}^{ii} \\ {A}_{p}^{ii} \\ {A}_{3}^{ii}\end{matrix} ) = {R}_{Θ , ϕ , ψ} ( \begin{matrix}{A}_{C}^{i} \\ {A}_{p}^{i} \\ {A}_{3}^{i}\end{matrix} ) \qquad ( 4 )$$

wherein A_{C}ⁱⁱ and Aₚⁱⁱ and A₃ⁱⁱ are the rotated attenuation components and wherein R_{Θ,φ,ψ}is the rotational transformation, which rotates the attenuation components A_{C}ⁱ and Aₚⁱ and A₃ⁱ by the rotational angles Θ, φ and ψ. If N attenuation components have been determined, the rotational transformation comprises preferentially (N²−N)/2 rotational angles, wherein these angles are preferentially determined by solving a system of equations analytically or numerically. Preferentially, the condition that determines the system of equations is given by the requirement that the attenuated components A_{C}ⁱⁱ and Aₚⁱⁱ and A₃ⁱⁱ should not be correlated any longer. This is achieved if the non-diagonal elements of the co-variance matrix Vⁱⁱ of A_{C}ⁱⁱ and Aₚⁱⁱ and A₃ⁱⁱ are set to zero. The co-variance matrix Vⁱⁱ is determined by the co-variance matrix Vⁱ of the attenuation components A_{C}ⁱ and Aₚⁱ and A₃ⁱ by Vⁱⁱ=R_{θ,φ,ψ}VⁱR_{θ,φ,ψ}. The elements of the co-variance matrix Vⁱ can be determined analytically or approximated numerically from a number of measurements as known by the person skilled in the art. The rotation of the attenuation components with the requirement that the attenuation components after the rotation should be uncorrelated can easily be extended to more attenuation components than three.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. The mere fact that certain features are recited a mutually different dependent claims does not indicate that a combination of these features can not be used to advantage.

The different units described above can be implemented as program code means on a computer system and/or as dedicated hardware. Functions, which are performed by the above described units, can also be performed by less or more units. For example, the steps 102 to 106 described above with reference to the flowchart shown in FIG. 2 can be performed by a single unit.

A computer program may be stored/distributed on a suitable medium, such as an optical storage medium or a solid-state medium supplied together with or as part of other hardware, but may also be distributed in other forms, such as via the internet or other wired or wireless telecommunication systems.

Any reference signs in the claims should not be construed as limiting the scope.

1. A projection system for producing attenuation components of projection data of a region of interest comprising
a projection data providing unit for providing energy-dependent projection data of the region of interest,
a calculation unit for calculating different attenuation components generated by different attenuation effects from the energy-dependent projection data, wherein the different attenuation components contribute to the projection data,
a transformation unit for transforming the attenuation components such that a correlation of the attenuation components is reduced.

2. The projection system as defined in claim 1,
wherein the transformation unit transforms the different attenuation components to the same unit.

3. The projection system as defined in claim 1,
wherein the transformation unit is adapted for
determining for each of several projection data a position within an attenuation component space, whose orthogonal axes are spanned by the attenuation components, wherein a set of projection data positions within the attenuation component space is formed,
determining major and minor axes of the set of projection data positions within the attenuation component space,
transforming the attenuation components such that the axes of the attenuation component space are parallel to the determined major and minor axes of the set of projection data positions.

4. The projection system as defined in claim 1,
wherein the transformation unit is adapted for performing a rotational transformation such that the correlation of the attenuation components is reduced.

5. The projection system as defined in claim 1,
wherein the projection system further comprises a processing unit for processing the attenuation components after having been transformed such that the correlation is reduced.

6. The projection system as defined in claim 5,
wherein projection system further comprises an inverse transformation unit for applying an inverse transformation to the processed attenuation components, which is inverse to the transformation of the transformation unit.

7. The projection system as defined in claim 1,
wherein the projection system further comprises a reconstruction unit for reconstructing an image of the region of interest using the transformed attenuation components.

8. A projection method for producing attenuation components of projection data of a region of interest comprising following steps:
providing energy-dependent projection data of the region of interest,
calculating different attenuation components generated by different attenuation effects from the energy-dependent projection data, wherein the different attenuation components contribute to the projection data,
transforming the attenuation components such that a correlation of the attenuation components is reduced.

9. A computer program for producing attenuation components of projection data of a region of interest, the computer program comprising program code means for causing a projection system as defined in claim 1 to carry out the steps of the method, when the computer program is run on a computer controlling the projection system.
